(19) United States
(12) Patent Application Publication
(10) Pub. No.: US 2013/0134698 A1
(43) Pub. Date: May 30, 2013

(54) SECURITY LABEL WITH EVIDENCE OF TAMPERING

(71) Applicants: Marco Mayrhofer, Sierning (AT); Georg Aigner, Pabneukirchen (AT)

(72) Inventors: Marco Mayrhofer, Sierning (AT); Georg Aigner, Pabneukirchen (AT)

(21) Appl. No.: 13/812,641

(22) PCT Filed: Jul. 30, 2011
(86) PCT No.: PCT/EP11/03834

§ 371 Date: Feb. 13, 2013

(30) Foreign Application Priority Data
Aug. 13, 2010 (AT) A 1357/2010

(51) Int. Cl. B42D 15/10

(52) U.S. Cl. CPC B42D 15/10
USPC 283/81; 283/74

(57) ABSTRACT

A tamper-evident adhesive security tape or label includes a flexible backing substrate based on a flexible polymeric film. One surface of the backing substrate bears an embossed varnish layer, a semitransparent metal layer and/or a high refractive index layer, a partial release varnish layer, one or more varnish layers having optical properties, and a self-adhesive coating. In the regions not coated with the release varnish layer, the adhesion of the layer to the layer and the adhesion of the layer to the article to be secured are greater than the adhesion of the layer to the layer, or the adhesion of the layer to the layer and the adhesion of the layer to the layer are greater than the adhesion of the layer to the article to be secured.

The invention relates to a tamper-evident adhesive security tape or label which has an optically active security feature and an optical feature.

An optically active feature for the present purposes comprehends diffractive structures, diffraction gratings, surface reliefs, holograms, kinegrams, and the like.

Adhesive security tapes or labels in the sense of the present invention fulfill two functions: on the one hand, the adhesive tape or label is intended to ensure the authenticity of a product or the integrity of a pack through the provision of an optically active security feature. Preference for this purpose is given to the use of holograms, which are well established in the product protection segment and therefore offer a high degree of acceptance, recognizability, and security. On the other hand, however, an attempt at tampering, in other words an unauthorized attempt to detach the adhesive tape or label, is to be clearly recognizable. The latter measure ensures that the user can be reasonably certain that a product protected with an adhesive tape or label of this kind is genuine and in its original packaging.

Typical holograms which are already being used today in product protection and as security features for documents of value customarily have a basic metallically lustrous appearance which gives rise, on a change in the viewing angle, to a play of rainbow colors as a result of diffraction of light at the structures of the hologram. These diffractive effects, however, are always very similar, and the metallic luster is common to all such products. Consequently there is a demand for new optically variable effects which differ from the conventional effect not only in the pattern of the hologram but also in the basic color and/or by virtue of a different luster.

Known from KR 10079525 is a hologram film and a method for its production. The construction there consists of a backing substrate, a release layer, an embossed layer (hologram layer), a partial metal layer, a masking layer, a print layer, and an adhesive layer. The print layer and the adhesive layer there have different fluorescent features. Evidence of tampering is not possible with this construction.

Known from EP-A 1 972 674 is a tamper-evident adhesive security tape or label where detachment of the label from the packaging or article that is to be secured reveals a hidden optical element.

It was an object of the invention, therefore, to provide an adhesive security tape or label which features not only an optically active security element but also optically recognizable evidence of tampering and which differs in its overall optical impression from conventional, metallically lustrous optically active structures.

The invention accordingly provides a tamper-evident adhesive security tape or label comprising a flexible backing substrate based on a flexible polymeric film, characterized in that one surface of the backing substrate bears the following applied layers:
a) an embossed layer,
b) a semitransparent metal layer or a high refractive index layer,
c) a partial release varnish layer in the form of letters, signs, symbols, lines, guilloches, numbers or writing,
d) one or more varnish layers having optical properties,
e) a self-adhesive coating,
where, in the regions not coated with the release varnish layer c),
the adhesion of all layers to one another and the adhesion of the layer e) to the article to be secured are greater than the adhesion of the layer d) to the layer e) or
the adhesion of ail layers to one another is greater than the adhesion of the layer e) to the article to be secured
and where,
in the regions coated with the release varnish layer c),
the adhesion of all the layers to one another and the adhesion of the layer e) to the article to be secured are greater than the adhesion of the layer c) to the layer b) or the adhesion of the layer c) to the layer d).

Examples of suitable backing substrates are backing films, preferably flexible polymeric films, comprising, for example, PI, PP, MOPP, PE, PPS, PEEK, PEK, PEI, PSU, PAEK, LCP, PEN, PBT, PET, PA, PC, COC, POM, ABS, PVC, fluoropolymers, such as commercial Teflon, and the like. The backing films preferably have a thickness of 5-700 nm, more preferably 5-200 μm, very preferably 5-100 μm.

In the first step, a varnish layer a) is applied to one surface of the backing substrate, and is embossed in the same operation or in a subsequent process. The adhesion of the varnish layer a) to the backing substrate must foe sufficient for the integrated layer system not to part along this interface when the label is detached from a liner or when the adhesive tape is unwound or when the tamper evidence feature is triggered.

If the adhesion of the varnish layer a) to the backing substrate is not great enough without further measures, then it is possible for an adhesion promoter layer, which improves the adhesion of the varnish layer a) to the backing substrate, to have been applied to the backing substrate prior to varnishing with the layer a). Alternatively a backing substrate appropriately pretreated by chemical or physical means can be used,

It may, however, be entirely desirable for the integrated layer system to separate at the interface between layer a) and the backing substrate, if, for example, the label is executed as what is called a transfer label. In this embodiment of the invention, the adhesion between layer a) and the backing substrate is lower than the adhesion of the layers a) to e) to one another. Following application of the label to an article by means of the adhesive layer, the backing substrate can be removed without triggering an evidence of tampering. This evidence of tampering then comes about, for example, as a result of the so-called tape test, in which an adhesive tape or another label is adhered to the layer system remaining on the article, and removed again. In that case the tamper evidence feature is triggered and a part, of the layers according to claim 1 is removed again.

In order to lower the adhesion, the backing substrate may be provided, for example, with a release layer. Where the embossed varnish layer a) already has poor adhesion to the backing substrate, without further measures, there is no need for a release layer for application as a transfer label.

Suitable release layers include, in particular, known poorly adhering varnish compositions, based for example on methacrylate. Furthermore, it is also possible to use very thinly applied oil layers or polyamide, polyethylene, silicone or fluoropolymer wax layers as release layers. Subsequently, as described above, the varnish layer a) is applied.

On the surface remote from the backing substrate, the varnish layer a) has a surface structure, as for example a surface relief, a hologram, a diffractive structure or a diffraction grating. This structure can be produced by means of known hot-stamping or UV embossing methods, by impression from structures present on an embossing die. When a hot-stamping method is used, the varnish layer a) is a thermoplastic varnish layer; when a UV embossing method is employed, the varnish layer a) is radiation-curing. Stamping and embossing methods of these kinds are well known to the skilled person, and are disclosed in EP-A 1 310 381, the content of which is hereby incorporated in full into the present specification.

The thickness of the applied varnish layer a) may vary depending on the end product requirement and thickness of the substrate, and in general is between 0.5 and 50 μm, preferably between 2 and 10 μm, more preferably between 2 and 5 μm.

The varnish layer a) is applied, over the full area or partially, by a coating process, such as spraying, pouring, curtain coating, slot-die coating, dipping or knife coating, for example, or by a printing process, as for example gravure, flexographic, offset, screen or digital printing.

Subsequently, a semitransparent metallic layer or a high refractive index layer b) is applied to the varnish layer a).

The semitransparent metallic layer b) has an optical density of around 0.1 to 1.3, preferably of 0.1 to 0.8. An optical density of this kind ensures that the layer is still sufficiently transparent for the layers situated behind it to foe still visible to the viewer.

Examples of suitable semitransparent metallic layers include layers comprising a metal or an alloy. Suitability as metal layer is possessed by layers comprising Al, Cu, Fe, Ag, Au, Cr, Ni, Zn, Sn, Pt, Ti, Pd, and the like. Examples of suitable alloys are Cu—Al alloys, Cu—Zn alloys, and the like.

The metallic layer is applied preferably by a PVD or CVD process (sputtering, vapor deposition, gas-phase deposition).

Alternatively the layer b) may be executed as an HRI (high refractive index) layer. This HRI layer may preferably consist of a varnish layer with a high refractive index, or of a layer comprising metal compounds. Examples of suitable metal compounds are oxides or sulfides of metals, more particularly TiO₂, Cr oxides, ZnS, Cu oxides, indium tin oxide, antimony tin oxide, antimony zinc oxide, FTO, ZnO, Al₂O₃, or silicon oxides.

Varnish layers with a high refractive index are applied preferably by known printing or coating processes (see above); HRI layers comprising metal compounds are applied preferably by a PVD or CVD process (sputtering, vapor deposition).

Subsequently a release varnish layer c) is applied partially, in the form, for example, of letters, signs, symbols, lines, guilloches, numbers or writing.

Suitable release varnish comprises preferably known, poorly adhering varnish compositions, based for example on cycloolefin copolymers, nitrocellulose, acrylates, polyvinyl chloride, ethylene-acrylate copolymers or styrene-acrylates in a suitable solvent. To adjust the adhesion it is preferred in this case to add chlorinated polyolefins. The fraction of the chlorinated polyolefins in the composition may be 0 to 130 wt. % in relation to the base polymer.

An alternative possibility is to use any desired varnish systems, their adhesion reduced by an additive, as for example a polyacrylate copolymer (available, for example, under the brand name BYK-394® from BYK-Chemie GmbH).

It is also possible, furthermore, to use very thinly applied polyamide, polyethylene, or fluoropolymer wax layers, or silicone coatings.

The release varnish layer may optionally be provided with security pigments such as fluorescent pigments and the like.

The adhesion of the release varnish layer c) is set so that when the tamper evidence feature is triggered, the release varnish coating c) parts either from the layer b) or the layer d), but the rest of the film construction remains intact, in its structure at these locations. In any case, the adhesion of the release varnish layer c) to the layer b) is lower than the adhesion of the semi transparent or HRI layer b) to the stamping/embossing varnish layer a).

The release varnish layer c) is applied partially by means of a printing process, such as by gravure, flexographic, offset, screen, or digital printing, for example.

Applied partially or over the full area to this release varnish layer are one or more varnish layers d) having optical properties.

The optical properties of the layer d), more particularly the color, can be brought about by means of dyes and/or pigments. Pigments which can be used include all known pigments, examples being inorganic-based pigments, such as titanium dioxide, zinc sulfide, kaolin, indium tin oxide, antimony tin oxide, fluorine tin oxide, aluminum, chromium oxides and silicon oxides, or organic-based pigments, such as phthalocyanine blue, isoindolidine yellow, dioxazine violet, and the like, and also colored and/or encapsulated pigments in chemically, physically or reactively drying binder systems. Suitable dyes include, for example, 1,1- or 1,2-chromium-cobalt complexes.

Additionally it is possible for effect and/or security dyes and/or pigments to be employed, examples being luminescent dyes and pigments, which fluoresce or phosphoresce in the visible, UV or IR range; effect pigments such as liquid crystals, mother-of-pearl, bronzes and/or multilayer color-change pigments and thermochromic inks and pigments. They can be used individually or in all possible combinations. Also conceivable are combinations of visible with invisible color pigments and effect pigments and/or security pigments.

This layer or these layers d) may also, however, have a defined color gradation, or else may be executed in multicolor printing with partial or full overlap above or alongside one another and in partial or full-area form.

The colored layer or layers d) are applied by any desired process, but preferably by a printing process.

The thickness of the color layers d) is a function of the desired hiding power of the color, in conjunction with the printing process used.

Subsequently a self-adhesive coating e) is applied. With the aid of the self-adhesive coating, the adhesive security tape or label is adhered to the article or pack that is to be secured.

As a result of the different partial adhesion relationships in the label, the varnish layer d) suffers destructive tearing on any attempt to remove the adhesive tape or label from the article to be secured. One part of the varnish layer d) remains on the article to be secured; the second part of the varnish layer d) is removed with the backing substrate from the article. The two parts have a complementary behavior relative to one another—that is, either positive structures are visible on the removed backing substrate and negative structures on the article, or vice-versa.

The following boundary conditions must be observed in every case in order to ensure a reliable operation:
In the regions not coated with the release varnish layer c), the lowest adhesion is either between the layer d) and the layer e) or between the layer e) and the article to be secured. All other adhesions are greater.
In the regions coated with the release varnish layer c), the lowest adhesion is either between the layer b) and the layer c) or between the layer c) and the layer d). All other adhesions, including the adhesion between the self-adhesive coating e) and the article to be secured, are greater.

In view of the particular circumstances when the tamper-evidence feature is triggered, these circumstances being unable to be foreseen by the label manufacturer, it is possible for different combinations of the above boundary conditions to occur in a single label. The design of the label, however, is initially selected such that in the two relevant regions (with and without release varnish c)), one of the two above cases preferentially occurs.

Optionally, the surface of the backing substrate situated opposite to the construction may additionally bear an applied print primer, which enables or facilitates subsequent printing of a label or adhesive tape.

This printing may consist, for example, of customer-specific or product-specific individual data, or else of any desired patterns, signs, symbols, and the like.

In the case of use as an adhesive tape, the second surface of the backing substrate may optionally bear an applied release varnish layer, in order to allow the tape to be wound up; in this case, the adhesion of the self-adhesive coating e) to this second release varnish layer is poorer than the adhesion to the integrated system formed by the layers a) to e).

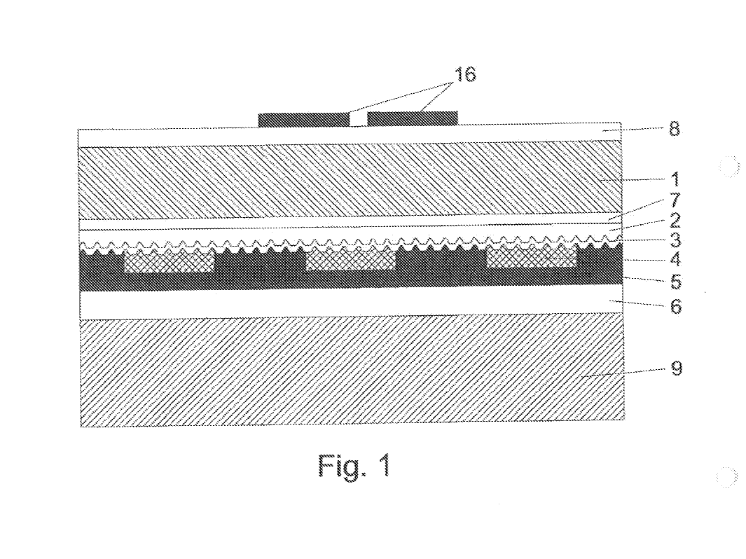

Embodiments in accordance with the invention are shown in FIGS. 1 to 5.

In these figures

1 denotes the backing substrate

2 denotes a varnish layer having an optically active structure (a hologram, for example)

3 denotes a semitransparent metal layer or an HRI layer

4 denotes the partial release varnish layer

5 denotes the layer having optical properties

6 denotes a self-adhesive coating

7 denotes an (optional) adhesion promoter layer

8 denotes an (optional) print primer layer

9 denotes the article bearing the applied adhesive tape or label

10, 11, 12, 13 denote regions having different adhesion conditions

14 denotes the part of the label that is removed with the backing; substrate 1

15 denotes the part of the label which remains on the article 9 to be secured

16 denotes customer-specific printing

17 denotes the security label of the invention

18 denotes the part of the layer having optical properties 5 that remains on the article 9 to be secured and exhibits negative recesses in the form of signs

19 denotes the part of the layer having optical properties 5 in the form of positive signs which is removed with the backing substrate 1

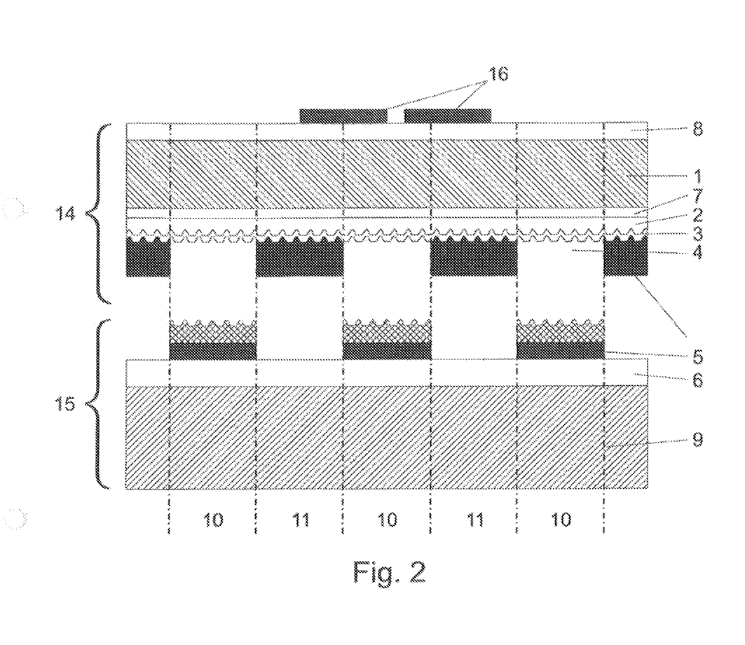

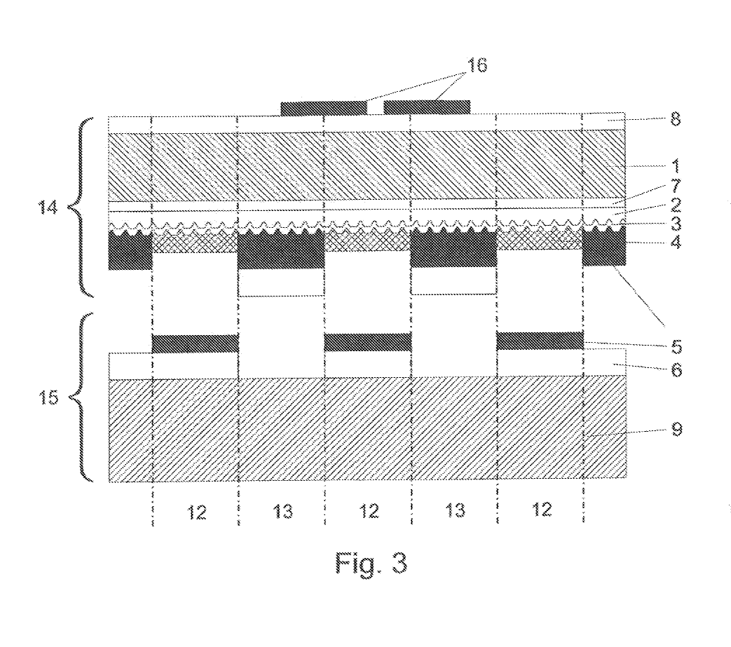

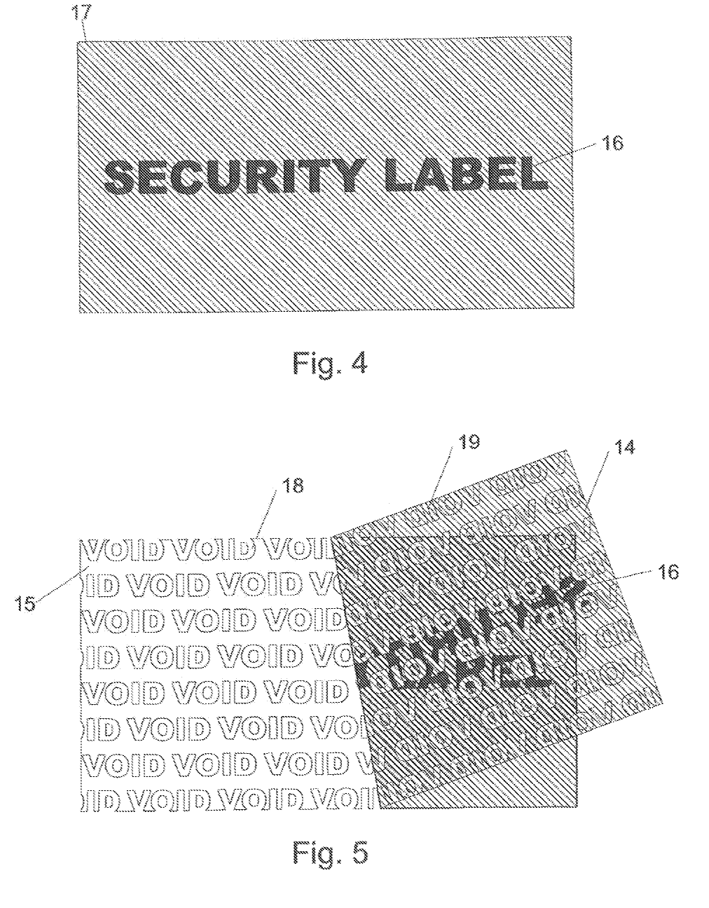

FIG. 1 shows, in cross section, the construction of the label in the adhered state. FIGS. 2 and 3 show, likewise in cross section, the state after triggering of the tamper evidence feature, with different triggering mechanisms of the invention. FIG. 4 shows a plan view of a security label of the invention; FIG. 5 shows the same security label with partially triggered tamper evidence feature.

In FIG. 1, a label of the invention has been adhered to an article 9. The label consists of a backing substrate 1, which is coated on one surface with a primer 8 and is subsequently printed with a visible motif 16. Located on the opposite surface is first an adhesion promoter layer 7, an embossed varnish layer 2, and a semi transparent metallic layer or a high refractive index layer 3.

Applied subsequently, to the layer 3, is a partial release varnish layer 4 which is covered by a layer having optical properties 5. The layer 5 is provided in turn with a self-adhesive coating 6, by which the adhesive tape or label is affixed on the article 9 to be secured.

FIG. 1 shows an example where the user views the optically active structure through the backing substrate 1; for this purpose, the backing substrate 1 is usefully implemented transparently. Through the semitransparent metal layer or HRI layer 3, the light is partially reflected at the interface with the layer 2, and the diffractive effect of the optically active structure becomes visible to the viewer. As a result of the partial translucency of the layer for visible light, however, the underlying layer having optical properties 5, as well, is still visible. Accordingly, the optically active structure and the color layer are superimposed on one another in an advantageous way. The ultimate impression given to the viewer is that of a hologram with a colored background, but one having no metallic luster, of the kind otherwise characteristic for conventional embossed and metalized holograms.

In FIGS. 2 and 3, the tamper evidence feature has been triggered by removal of the label. It can clearly be seen that parts of the layer having optical properties 5 remain on the article 9 to be secured, and do so exactly in those regions in which the release varnish layer 4 has been printed on. In the regions without release varnish layer 4, the layer having optical properties 5 remains on the removed backing substrate 1 and on the hologram applied to it. This “destructive tearing” of the layer 5 gives the viewer optical evidence of tampering, in the form of letters, signs, symbols, lines, guilloches, numbers, or writing. FIGS. 2 and 3 differ from one another in the precise configuration of the adhesion relationships between the individual layers. The regions 10 to 13 make clear these inventive adhesion relationships between the individual layers, which lead to the revelation of the optical effect when the tamper evidence feature is triggered.

In the region 10, the integrated system separates between the semi transparent metallic or HRI layer 3 and the release varnish layer 4—in other words, the adhesion between the layers 3 and 4 is lower than the adhesion of all other layers to one another and than the adhesion of the self-adhesive coating 6 to the article 9. The layer having optical properties 5 therefore remains in the region 10 in unison with the self-adhesive coating 6 and the release varnish layer 4 on the article 9 to be secured.

In the region 11, the integrated system separates between the layer having optical properties 5 and the self-adhesive coating 6—in other words, the adhesion between the layers 5 and 6 is lower than the adhesion of ail other layers to one another and than the adhesion of the self-adhesive coating 6 to the article 9. The layer having optical properties 5 therefore remains in the region 11 in unison with the stamping/embossing varnish layer 2 and the semitransparent metallic or HRI layer 3 on the removed backing substrate 1.

In the region 12, the integrated system separates between the release varnish layer 4 and the layer having optical properties 5—in other words, the adhesion between the layers 4 and 5 is lower than the adhesion of all other layers to one another and than the adhesion of the self-adhesive coating 6 to the article 9. The layer having optical properties 5 therefore remains in the region 10 in unison with the self-adhesive coating 6 on the article 9 to be secured. In the region 13, the self-adhesive coating 6 parts from the article 9 to be secured—in other words, the adhesion of the self-adhesive coating 6 to the article 9 is lower than the adhesion of all other layers to one another. The layer having optical properties 5 therefore remains in the region 11 in unison with the stamping/embossing varnish layer 2, the semitransparent metallic or HRI layer 3, and the self-adhesive coating 6 on the removed backing substrate 1.

The above adhesion relationships need not necessarily be combined in the manner shown in FIGS. 2 and 3, but instead may also occur in the combination of the situation of region 10 with region 13 or in the combination of the situation of region 11 with region 12. Depending on the design of the label of the invention, a particular combination of the adhesions arises; however, as a result of the unforeseeable way in which the tamper evidence feature is activated in detail, in other words how the backing substrate is removed, it may also be the case that all of the release situations shown for the regions 10 to 13 occur simultaneously on a single label.

It can clearly be seen that in the regions 11 and 13, the self-adhesive coating 6 ends up exposed after the tamper evidence feature has been triggered; in other words, if the surface of the article with the layers that have remained on the article is engaged, the residue 15 in the regions 11 is sticky. In the regions 13, the self-adhesive layer 6 remains on the removed part 14 of the label, and hence the removed part 14 is sticky in the regions 13. It is therefore possible, following triggering of the tamper evidence feature, for the adhesive tape or label to be reaffixed on the article 9, but the tamper evidence is always visible, since the adhesive tape or label can no longer be positioned so precisely that the two parts of the layer having optical properties 5 come to lie congruently with one another again.

FIG. 4 shows the security label 17 of the invention in a plan view, a customer-specific print 16 having been applied to its facing side, in the adhered state prior to tampering.

FIG. 5 shows the security label of the invention in a partially removed state—that is, with a partially activated tamper evidence feature. Remaining on the article to be secured is the part 15 of the label that has recesses in the layer having optical properties 5, in the form of negative signs 18 (“VOID”). The part of the layer having optical properties 5 that remains on the removed part of the label 14 is in the form of positive signs 19.

### Example Construction 1 (Printable Security Label)

| | | Thickness/ | |
|---|---|---|---|
| Reference | | application | |
| sign | Layer | rate | Composition |
| 8 | Print primer | 1 g/m² | Polyester-based varnish |
| | | | system, crosslinking, |
| | | | solvent: methyl ethyl |
| | | | ketone |
| 1 | Backing substrate | 50 μm | PET |
| 7 | Primer | 0.5 g/m² | Acrylate-based varnish |
| | | | system crosslinked with |
| | | | isocyanates, solvent: |
| | | | ethyl acetate |
| 2 | UV varnish with | 3 g/m² | Acrylate-based varnish |
| | hologram | | system with |
| | embossing | | photoinitiator, |
| | | | undiluted |
| 3 | Semitransparent | 0.5 OD | Aluminum, applied by |
| | metal layer | (about | vapor deposition |
| | | 6.5 nm) | |
| 4 | Release varnish, | 0.2 g/m² | Cycloolefin copolymer |
| | partial | | with 50% chlorinated |
| | | | polyolefins, solvent: |
| | | | xylene |
| 5 | Colored, | 4 g/m² | PVC binder-based |
| | pigmented varnish | | varnish with 15% red |
| | | | color pigments, |
| | | | solvent: ethyl acetate |
| 6 | Self-adhesive | 10 g/m² | |
| | coating | | |

### Example Construction 2 (Security Label)

| | | Thickness/ | |
|---|---|---|---|
| Reference | | application | |
| sign | Layer | rate | Composition |
| 1 | Backing substrate | 23 μm | PET, chemically |
| | | | pretreated on one side |
| 2 | UV varnish with | 3 g/m² | Acrylate-based varnish |
| | hologram | | system with |
| | embossing | | photoinitiator, |
| | | | undiluted |
| 3 | HRI coating | 50 nm | ZnS, applied by vapor |
| | | | deposition |
| 4 | Release varnish, | 0.2 g/m² | Cycloolefin copolymer |
| | partial | | with 50% chlorinated |
| | | | polyolefins, solvent: |
| | | | xylene |
| 5 | Multicolored | 4 g/m² per | PVC binder-based |
| | printing, | color | varnishes with 15% |
| | partially | | each of red, blue or |
| | alongside one | | white color pigments, |
| | another | | solvent: ethyl acetate |
| 6 | Self-adhesive | 10 g/m² | |
| | coating | | |

### Example Construction 3 (Adhesive Security Tape)

| | | Thickness/ | |
|---|---|---|---|
| Reference | | application | |
| sign | Layer | rate | Composition |
| | Release varnish | 0.1 g/m² | Silicon coating |
| | layer | | |
| 1 | Backing substrate | 23 μm | PET |
| 7 | Primer | 0.5 g/m² | Acrylate-based varnish |
| | | | system crosslinked |
| | | | with isocyanates, |
| | | | solvent: ethyl acetate |
| 2 | Hot-stamping | 3 g/m² | PMMA-based varnish |
| | varnish | | system, solvent: ethyl |
| | | | acetate |
| 3 | Semitransparent | 0.5 OD | Aluminum, applied by |
| | metal layer | (about 6.5 nm) | vapor deposition |
| 4 | Release varnish, | 0.2 g/m² | PVC binder-based |
| | partial | | varnish with 2% |
| | | | adhesion additive |
| | | | (polyacrylate |
| | | | copolymer) in solvent: |
| | | | ethyl acetate |
| 5 | Colored varnish | 3 g/m² | Nitrocellulose binder- |
| | with color | | based varnish with 10% |
| | pigments and UV | | yellow color pigments |
| | pigments | | and 10% pigments |
| | | | exhibiting red |
| | | | fluorescence under UV |
| | | | light, solvent: ethyl |
| | | | acetate |
| 6 | Self-adhesive | 15 g/m² | |
| | coating | | |

1. A tamper-evident adhesive security tape or label comprising a flexible backing substrate based on a flexible polymeric film, characterized in that one surface of the backing substrate bears the following applied layers:
a) an embossed varnish layer,
b) a semitransparent metal layer and/or a high refractive index layer,
c) a partial release varnish layer 4 in the form of letters, signs, symbols, lines, guilloches, numbers or writing,
d) one or more varnish layers having optical properties,
e) a self-adhesive coating,
where, in the regions not coated with the release varnish layer, the adhesion of all the layers to one another and the adhesion of the layer to the article to be secured are greater than the adhesion of the layer to the layer, or the adhesion of all layers to one another is greater than the adhesion of the layer to the article to be secured, and where, in the regions coated with the release varnish layer, the adhesion of all layers to one another and the adhesion of the layer to the article to be secured are greater than the adhesion of the layer to the layer 4 or the adhesion of the layer 4 to the layer.

2. The adhesive security tape or label of claim 1, wherein the backing substrate 1 consists of a transparent polymeric film.

3. The adhesive security tape or label claim 1. wherein the other surface of the backing substrate bears a print primer layer.

4. The adhesive security tape or label of claim 1, wherein the other surface of the backing substrate bears a release varnish layer.

5. The adhesive security tape or label of claim 1, wherein situated between backing substrate and embossed varnish layer is an adhesion promoter layer.

6. The adhesive security tape or label of claim 1, wherein backing substrate and embossed varnish layer is a release layer.

7. The adhesive security tape or label claim 1, wherein the layer having optical properties is executed in multicolor printing, as a color gradation layer and/or as a layer comprising effect and/or security dyes or pigments.

8. The adhesive security tape or label of claim 1, wherein, after the triggering of the tamper evidence feature, letters, signs, symbols, lines, guilloches, numbers or writing become recognizable that are positive on the article to be secured and negative on the removed backing substrate, or vice-versa.

9. The adhesive security tape or label of claim 1, wherein the layer is a semitransparent metal comprising Al, Cu, Fe, Ag, Au, Cl, Ni, Zn, Sn, Pt, Ti or Pd or comprising an alloy of these metals.

10. The adhesive security tape or label of claim 1, wherein the layer is an HRI layer comprising a metal compound.

11. The adhesive security tape or label claim 1, wherein the layer is an HRI varnish layer.

12. The adhesive security tape or label of claim 1, wherein the layer is an embossed UV varnish layer.

13. The adhesive security tape or label of claim 1, wherein the layer is a hot-stamping varnish layer.

14. The adhesive security tape or label of claim 1, wherein the adhesive tape or label has printing on the print primer layer or on the uncoated surface of the backing substrate.

15. The adhesive security tape or label of claim 1, wherein the varnish layer has embossing in the form of a hologram, a diffractive structure or a diffraction grating.

16. The adhesive security tape or label of claim 15, wherein it imparts the visual impression of a hologram with a colored background and possesses no metallically reflecting character.
